(19) United States
(12) Patent Application Publication
(10) Pub. No.: US 2024/0383439 A1
(43) Pub. Date: Nov. 21, 2024

(54) SMART VEHICLE SYSTEMS AND CONTROL LOGIC FOR AUTOMATING QUALIFICATION CHECKS FOR REMOTE VEHICLE SERVICES

(71) Applicant: GM GLOBAL TECHNOLOGY OPERATIONS LLC, Detroit, MI (US)

(72) Inventors: Ali H. Fawaz, Dearborn Heights, MI (US); Scott T. Droste, West Bloomfield, MI (US); Benjamin Tran, Royal Oak, MI (US); Robert Myers, Canton, MI (US); Ryan J. Baik, Troy, MI (US)

(73) Assignee: GM GLOBAL TECHNOLOGY OPERATIONS LLC, Detroit, MI (US)

(21) Appl. No.: 18/320,595

(22) Filed: May 19, 2023

(51) Int. Cl. B60R 25/04; B60W 10/04; B60W 50/14; H04W 4/40

(52) U.S. Cl. CPC B60R 25/04; B60W 10/04; B60W 50/14; H04W 4/40; B60W 2556/10; B60W 2556/45

(57) ABSTRACT

Presented are vehicle control systems and logic for provisioning remote vehicle services (RVS), methods for making/using such systems, and wireless-enabled vehicles executing RVS operations governed by such systems. A method of controlling an RVS operation of a vehicle includes a vehicle controller receiving, either directly or indirectly, a request to activate the RVS operation. Responsive to receiving the RVS activation request, wireless signal data is collected to determine wireless signal states of the subject vehicle and of multiple crowd-sourced vehicles proximal to the subject vehicle. Using the host vehicle's and crowd-sourced vehicles' wireless signal states, a signal state heatmap is generated with a spatial mapping of signal state magnitudes as a map overlay. The heatmap visualizes a signal state magnitude in an area surrounding the host vehicle. If this signal state magnitude exceeds a preset minimum threshold, the vehicle controller commands a resident vehicle subsystem to activate the RVS operation.

### INTRODUCTION

The present disclosure relates generally to motor vehicles with remote vehicle services capabilities. More specifically, aspects of this disclosure relate to systems and methods for governing remote ignition block (RIB) operations for connected vehicles.

Current production motor vehicles, such as the modern-day automobile, may be equipped with a network of onboard sensors, electronic controllers, and wireless communications devices that provide automated driving capabilities, navigation assistance, and other vehicle services. As vehicle processing, communication, and sensing capabilities improve, manufacturers persist in offering more automated driving capabilities with the aspiration of producing fully autonomous “self-driving” vehicles competent to navigate among heterogeneous vehicle types in both urban and rural scenarios. Original equipment manufacturers are moving towards vehicle-to-vehicle (V2V) and vehicle-to-everything (V2X) “talking” cars with higher-level driving automation that employ autonomous control systems to enable vehicle routing with steering, lane changing, scenario planning, etc. In addition to fully and partially autonomous driving capabilities, many vehicles now enable remotely controlled “connected” services, such as remote engine start (RES), remote lock control, remote ignition block (RIB), remote vehicle locator, remote door control, etc.

To provide users with remote vehicle services and other functionality, many vehicle passenger compartments are now furnished with a center-stack telematics unit that enables the sending, receiving, and storing of information using wireless connectivity. The telematics unit may wirelessly connect to a cellular network for such purposes as real-time navigation, customer support, vehicle tracking, system diagnostics, traffic data, and fleet management. In general, the telematics unit functions as a bidirectional radio transceiver that is able to simultaneously transmit and receive data in the form of network data packets. Data packets may be transmitted via UHF, SHF and/or EHF radio signal from a cell tower to a cellular-enabled vehicle via downlink (or download) transmission and, conversely, may be transmitted via uplink (or upload) transmission from the vehicle to a cell tower. Uplink/downlink signal disturbances in a cellular network may cause weak or intermittent signals that lead to disruptions in a vehicle's wireless communication functionality.

### SUMMARY

Presented herein are intelligent vehicle systems with attendant control logic for provisioning remotely controlled (remote) vehicle services, methods for manufacturing and methods for operating such systems, and wireless-enabled vehicles interoperable with such systems to govern remote vehicle services. By way of illustration, and not limitation, systems and methods are presented for automating qualification checks for remote vehicle services based on real-time and predicted wireless signal strength of the subject “host” vehicle. A vehicle owner, operator, occupant, renter, lessee, etc. (collectively “user”), for example, may submit a request-through a mobile app, key fob, or other wireless-enabled device—to activate a remote ignition block feature that prevents restarting of the host vehicle's prime mover(s) after the vehicle powertrain is turned off. Prior to activation, the intelligent vehicle system may aggregate signal quality data from the host vehicle and crowd-sourced vehicles in proximity to the host vehicle to determine a cellular signal state, nay signal quality (decibels (dB)) and signal strength (decibel milliwatts (dBm)), in the surrounding area. If the signal state is deemed insufficiently robust to support cellular communications with the host, the system may notify the user and deny the RIB request.

While remote ignition block is active, the intelligent vehicle system may continually monitor signal strength and quality of the host vehicle and surrounding vehicles to create and update in real-time a heatmap of signal quality in the host vehicle's surrounding area. The system may aggregate, filter, and preprocess these datapoints for use as inputs in a Spatiotemporal Forecasting (STF) Model to predict a future signal state heatmap for the vehicle's surrounding area. The system systematically references this forecasted signal state heatmap to predict a poor signal quality in the vehicle's location and automate ameliorative action. By acting before poor signal quality/strength potentially undermines remote vehicle services, the vehicle system is able to provide accurate, up-to-date information to the user so that RIB may be denied or deactivated while sufficient signal quality is still available to wirelessly communicate with the host vehicle.

Attendant benefits for at least some of the disclosed concepts include intelligent vehicle control protocols that eliminate or minimize the number of failed or inaccessible remote vehicle services resulting from poor cellular signal quality. For RIB or RES applications, for example, disclosed features may help to prevent vehicles from being inadvertently rendered inoperable or locked in an undesirable state (e.g., precluding a valid key-on request and creating a “walk-home” situation). Other attendant advantages may include the system automating transmission of electronic notifications to users informing them of the predicted poor signal quality and enabling them to take preventative action. Calibratable remote vehicle services settings may also help to dynamically tailor system response to individual event and vehicle needs.

Aspects of this disclosure are directed to intelligent vehicle control systems, system control logic, and memory-stored instructions for governing remote vehicle services (RVS). In an example, a method is presented for controlling an RVS operation of a host vehicle, which has wireless short-range communications (SRC) and long-range communications (LRC) devices and a resident or remote controller or module or network of controllers/modules (collectively “controller”). This representative method includes, in any order and in any combination with any of the above and below disclosed options and features: receiving, e.g., via the vehicle controller over a wireless communications device either directly or through a back-office (BO) vehicle services provider (e.g., ONSTAR® or MYGMC®), an activation signal indicative of a request to activate an RVS operation; retrieving, e.g., via the controller and/or BO responsive to receipt of the RVS activation signal, wireless signal data indicative of wireless signal states of the host vehicle and multiple crowd-sourced vehicles within a predefined proximity of the host vehicle (e.g., half-kilometer (km) radius geofence); generating, e.g., via the vehicle controller or BO using the host vehicle's and crowd-sourced vehicles' wireless signal states, a signal state heatmap with a spatial mapping of signal state magnitudes overlaid on a map and including a signal state magnitude in a surrounding area of the host vehicle; determining if this surrounding signal state magnitude exceeds a preset minimum signal state threshold; and transmitting, e.g., via the vehicle controller responsive to the host signal state magnitude exceeding the preset minimum signal state threshold, one or more command signals to one or more resident vehicle subsystems of the host vehicle to activate the RVS operation.

Aspects of this disclosure are also directed to computer-readable media (CRM) for provisioning remote vehicle services for motor vehicles. In an example, non-transitory CRM store instructions that are executable by a host vehicle's controller and/or a BO vehicle service system's controller. When executed, these instructions cause the controllers to perform operations, including: receiving, e.g., via the vehicle controller and/or the BO controller over a wireless communications device, an RVS activation signal indicative of a request to activate an RVS operation; retrieving, e.g., via the vehicle controller and/or the BO controller responsive to receipt of the RVS activation signal, wireless signal data indicative of a host wireless signal state of the host vehicle and crowd wireless signal states of multiple crowd-sourced vehicles within a predefined proximity to the host vehicle; generating, e.g., via the vehicle controller and/or the BO controller using the host wireless signal state and the crowd wireless signal states, a signal state heatmap with a spatial mapping of signal state magnitudes overlaid on a map and including a host signal state magnitude in a surrounding area of the host vehicle; determining, e.g., via the vehicle controller and/or BO controller, if the host signal state magnitude exceeds a preset minimum signal state threshold; and transmitting, via the vehicle controller responsive to the host signal state magnitude exceeding the preset minimum signal state threshold, a command signal to a resident vehicle subsystem to activate the RVS operation.

Additional aspects of this disclosure are directed to connected vehicles with remote vehicle services capabilities. As used herein, the terms “vehicle” and “motor vehicle” may be used interchangeably and synonymously to reference any relevant vehicle platform, such as passenger vehicles (ICE, HEV, FEV, fuel cell, fully and partially autonomous, etc.), commercial vehicles, industrial vehicles, tracked vehicles, off-road and all-terrain vehicles, motorcycles, farm equipment, watercraft, aircraft, etc. In an example, a smart vehicle network contains one or more host vehicles, each of which includes a vehicle body with a passenger compartment, multiple road wheels mounted to the vehicle body (e.g., via corner modules coupled to a unibody or body-on-frame chassis), and other standard original equipment. A vehicle powertrain with one or more primer movers (e.g., internal combustion engine (ICE) and/or electric traction motor) is attached to the vehicle body and operable to drive one or more of the road wheel to thereby propel the vehicle.

Continuing with the preceding discussion, each host vehicle is also equipped with a vehicle controller (e.g., single controller, network of controllers, resident/remote controller(s) or module(s), etc.) that is programmed to receive, e.g., over a wireless communications device directly or indirectly from a wireless-enabled computing device of a user of the host vehicle, an electronic request to activate an RVS operation. Upon receipt of an RVS approval notification from a BO vehicle services system, the vehicle controller commands one or more resident vehicle subsystems to activate/execute the requested RVS operation. Responsive to receipt of the RVS activation request, the BO controller collects wireless signal data indicative of wireless signal states (i.e., strength and/or quality) of the host vehicle and multiple crowd-sourced vehicles within a predefined proximity to the host vehicle. Using this wireless signal state data, the BO controller generates a signal state heatmap with a spatial mapping of signal state magnitudes overlaid on a map; this heatmap includes a signal state magnitude in a surrounding area of the host vehicle. The BO controller then determines whether or not this surrounding signal state magnitude exceeds a preset minimum signal state threshold; if so, the BO controller responsively transmits the RVS approval notification to the host vehicle, which then activates the RVS.

For any of the disclosed systems, methods, and CRM, the host vehicle controller and/or BO system controller may collect new wireless signal data indicative of new wireless signal states of the host vehicle and the crowd-sourced vehicles after the RVS operation is activated. Using a spatiotemporal forecasting model with the new wireless signal states as inputs to the STF model, the vehicle/BO controller may generate an updated (“predicted”) signal state heatmap spatially mapping predicted signal state magnitudes as a new map overlay; this new heatmap includes a predicted signal state magnitude in the surrounding area of the host vehicle. In this instance, the vehicle/BO controller determines whether or not the host vehicle's predicted signal state magnitude exceeds the preset minimum signal state threshold; if it does not, the vehicle controller may responsively command the resident vehicle subsystem(s) to deactivate the RVS operation. When the predicted host signal state magnitude does not exceed the signal state threshold, an electronic notification may be sent to a user of the host vehicle warning that the RVS operation is being deactivated. As a further option, the vehicle/BO controller may access a resident or remote memory device to retrieve historical wireless signal state data for the host vehicle and crowd-sourced vehicles; these historical wireless signal states may be used as inputs by the STF model to generate the new/predicted signal state heatmap.

For any of the disclosed systems, methods, and CRM, the vehicle/BO controller may respond to the host vehicle's predicted signal state magnitude exceeding the minimum signal state threshold by looping to a time delay operation that lasts a predefined wait time (e.g., one (1) minute refresh rate). After completing the time delay operation, the vehicle/BO controller collects updated (“new”) wireless signal data indicative of updated signal states of the host vehicle and the crowd-sourced vehicles. Using the updated/new wireless signal states as inputs to the STF model, the controller generates a new predicted signal state heatmap with a spatial mapping of new predicted signal state magnitudes as a new map overlay; this new/updated heatmap includes a new predicted host signal state magnitude for the surrounding area of the host vehicle. After the RVS operation is activated, the vehicle/BO controller may receive a deactivation request from the vehicle user or other authorized party to deactivate the RVS operation; upon receipt of the deactivation request, the vehicle controller may responsively deactivate the RVS operation.

For any of the disclosed systems, methods, and CRM, generating a signal state heatmap—be it a new, updated, predicted, etc.—may include identifying one or more transient regions in the signal state heatmap, each of which is located between an adjacent pair of signal state magnitudes yet lacks its own signal state magnitude. In this instance, a transient signal state magnitude may be estimated for each transient region by interpolating between the corresponding pair of signal state magnitudes. As yet another option, the vehicle/BO controller may respond to the host vehicle's signal state magnitude not exceeding the signal state threshold by transmitting an electronic notification to a user of the host vehicle warning that activation of the RVS operation is denied. In this instance, the vehicle/BO controller may thereafter receive an electronic override signal indicative of a selection from the user to override the denial of the RVS operation. Upon receipt of the override request, the vehicle controller may command the resident vehicle subsystem(s) to activate the RVS operation.

For any of the disclosed systems, methods, and CRM, receiving an RVS activation request may include a user of the host vehicle entering a request to activate the RVS operation via a wireless-enabled personal computing device; the personal computing device then transmits the activation request over a cellular network either directly to the vehicle controller or indirectly to the vehicle controller via the BO vehicle services system. As another option, the resident vehicle subsystem may include a vehicle powertrain with a prime mover and a powertrain control module (PCM). In this instance, the RVS operation may include a remote ignition block operation; the controller-output command signal may cause the PCM to prevent activation of the prime mover. As yet a further option, each of the wireless signal states of the host and crowd-sourced vehicles may include a corresponding signal strength value and/or a corresponding signal quality value.

The above summary does not represent every embodiment or every aspect of the present disclosure. Rather, the foregoing summary merely provides a synopsis of some of the novel concepts and features set forth herein. The above features and advantages, and other features and attendant advantages of this disclosure, will be readily apparent from the following Detailed Description of illustrated examples and representative modes for carrying out the disclosure when taken in connection with the accompanying drawings and appended claims. Moreover, this disclosure expressly includes any and all combinations and subcombinations of the elements and features presented above and below.

### BRIEF DESCRIPTION OF THE DRAWINGS

FIG. 1 is a partially schematic, side-view illustration of a representative intelligent motor vehicle with a network of in-vehicle controllers, sensing devices, and communication devices connected to a smart vehicle system for provisioning enhanced remote vehicle services in accord with aspects of the present disclosure.

FIG. 2 is a flowchart illustrating a representative intelligent vehicle qualification check for governing remote vehicle services, which may correspond to memory-stored instructions that are executable by a resident or remote controller, control-logic circuit, programmable control unit, or other integrated circuit (IC) device or network of devices in accord with aspects of the disclosed concepts.

FIGS. 3A and 3B are illustrations of examples of dynamically generated signal state heatmaps spatially mapping wireless signal state magnitudes of a host vehicle when located in a poor signal state area (FIG. 3A) or in a robust signal state area (FIG. 3A).

The present disclosure is amenable to various modifications and alternative forms, and some representative embodiments of the disclosure are shown by way of example in the drawings and will be described in detail herein. It should be understood, however, that the novel aspects of this disclosure are not limited to the particular forms illustrated in the above-enumerated drawings. Rather, this disclosure covers all modifications, equivalents, combinations, permutations, groupings, and alternatives falling within the scope of this disclosure as encompassed, for example, by the appended claims.

### DETAILED DESCRIPTION

This disclosure is susceptible of embodiment in many different forms. Representative embodiments of the disclosure are shown in the drawings and will herein be described in detail with the understanding that these embodiments are provided as an exemplification of the disclosed principles, not limitations of the broad aspects of the disclosure. To that extent, elements and limitations that are described, for example, in the Abstract, Introduction, Summary, Description of the Drawings, and Detailed Description sections, but not explicitly set forth in the claims, should not be incorporated into the claims, singly or collectively, by implication, inference, or otherwise. Moreover, recitation of “first”, “second”, “third”, etc., in the specification or claims is not used to establish a serial or numerical limitation; unless specifically stated otherwise, these designations may be used for ease of reference to similar features in the specification and drawings and to demarcate between similar elements in the claims.

For purposes of this Detailed Description, unless specifically disclaimed: the singular includes the plural and vice versa; the words “and” and “or” shall be both conjunctive and disjunctive; the words “any” and “all” shall both mean “any and all”; and the words “including,” “containing,” “comprising,” “having,” and the like, shall each mean “including without limitation.” Moreover, words of approximation, such as “about,” “almost,” “substantially,” “generally,” “approximately,” and the like, may each be used herein to denote “at, near, or nearly at,” or “within 0-5% of,” or “within acceptable manufacturing tolerances,” or any logical combination thereof, for example. Lastly, directional adjectives and adverbs, such as fore, aft, inboard, outboard, starboard, port, vertical, horizontal, upward, downward, front, back, left, right, etc., may be with respect to a motor vehicle, such as a forward driving direction of a motor vehicle when the vehicle is operatively oriented on a horizontal driving surface.

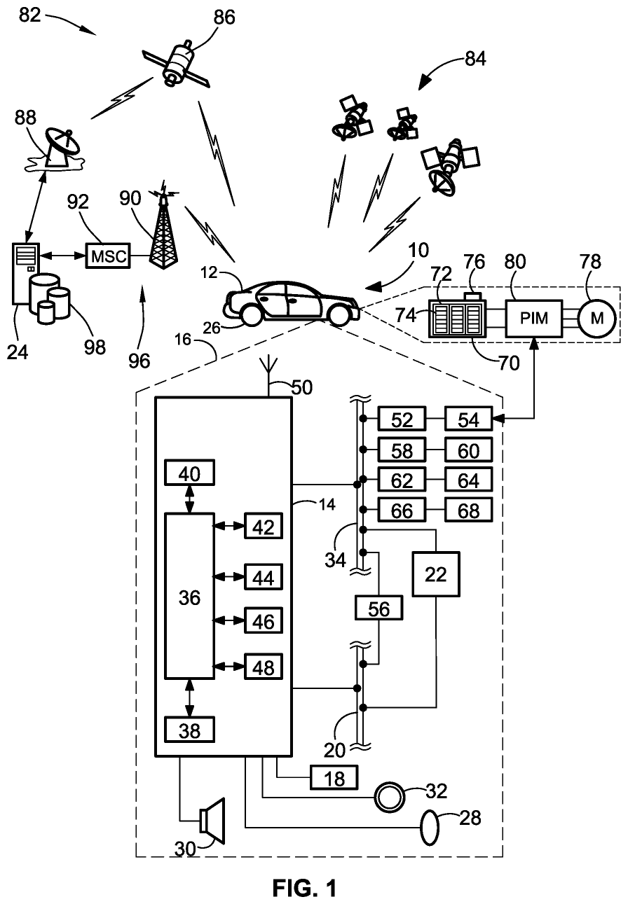

Referring now to the drawings, wherein like reference numbers refer to like features throughout the several views, there is shown in FIG. 1 a representative motor vehicle, which is designated generally at 10 and portrayed herein for purposes of discussion as a sedan-style, electric-drive automobile. The illustrated automobile 10—also referred to herein as “motor vehicle” or “vehicle” for short—is merely an exemplary application with which aspects of this disclosure may be practiced. In the same vein, incorporation of the present concepts into the illustrated wireless communications network for V2X data exchanges for provisioning remote vehicle services of connected vehicles should also be appreciated as a non-limiting implementation of disclosed features. As such, it will be understood that aspects and features of this disclosure may be applied to other wireless network architectures, implemented for a myriad of different RVS operations, and incorporated into any logically relevant type of vehicle. Moreover, only select components of the motor vehicles and vehicle control systems are shown and described in additional detail herein. Nevertheless, the vehicles and systems discussed below may include numerous additional and alternative features, and other available peripheral components, for carrying out the various methods and functions of this disclosure.

The representative vehicle 10 of FIG. 1 is originally equipped with a vehicle telecommunications and information (“telematics”) unit 14 that wirelessly communicates, e.g., via cell towers, wireless modem, mesh network, satellite service, etc., with a remotely located back-office (BO), cloud-computing host service 24 (e.g., ONSTAR®). Some of the other vehicle hardware components 16 shown generally in FIG. 1 include, as non-limiting examples, an electronic video display device 18, a microphone 28, audio speakers 30, and assorted user input controls 32 (e.g., buttons, knobs, switches, touchpads, joysticks, touchscreens, etc.). These hardware components 16 function, in part, as a human-machine interface (HMI) that enables a user to communicate with the telematics unit 14 and other components resident to and remote from the vehicle 10. Microphone 28, for instance, provides occupants with a means to input verbal or other audible commands; the vehicle 10 employs an embedded voice-processing unit utilizing audio filtering, editing, and analysis modules to convert the inputs to signals. Conversely, the speakers 30 provide audible output to a vehicle occupant and may be either a stand-alone speaker dedicated for use with the telematics unit 14 or may be a part of an audio system 22. The audio system 22 is operatively connected to a network connection interface 34 and an audio bus 20 to receive analog information, rendering it as sound, via one or more speaker components.

Communicatively coupled to the telematics unit 14 is a network connection interface 34, suitable examples of which include twisted pair/fiber optic Ethernet switches, parallel/serial communications buses, local area network (LAN) interfaces, controller area network (CAN) interfaces, and the like. The network connection interface 34 enables the vehicle hardware 16 to send and receive signals with one another and with various systems both onboard and off-board the vehicle body 12. This allows the vehicle 10 to automate assorted vehicle functions, such as modulating powertrain output, activating friction or regenerative brakes, controlling vehicle steering, managing operation of a traction battery pack, controlling vehicle windows, doors, and lock, and other automated functions. For instance, telematics unit 14 may exchange signals with a Powertrain Control Module (PCM) 52, an Advanced Driver Assistance System (ADAS) module 54, an Electronic Battery Control Module (EBCM) 56, a Steering Control Module (SCM) 58, a Brake System Control Module (BSCM) 60, and assorted other vehicle ECUs, such as a transmission control module (TCM), engine control module (ECM), Sensor System Interface Module (SSIM), etc.

With continuing reference to FIG. 1, telematics unit 14 is an onboard computing device that provides a mixture of services, both individually and through its communication with other networked devices. This telematics unit 14 is generally composed of one or more processors 40, each of which may be embodied as a discrete microprocessor, a multicore processor, an application specific integrated circuit (ASIC), a dedicated control module, or other suitable IC device or network of devices. Vehicle 10 may offer centralized vehicle control via a central processing unit (CPU) 36 that is operatively coupled to a real-time clock (RTC) 42 and one or more electronic memory devices 38, each of which may take on the form of a CD-ROM, magnetic disk, IC memory device, solid-state drive (SSD) memory, hard-disk drive (HDD) memory, flash memory, semiconductor memory (e.g., various types of RAM or ROM), etc.

Long-range communication (LRC) capabilities with remotely located off-board devices may be provided via one or more or all of a cellular chipset, an ultra-high frequency radio transceiver, a satellite-communication (SATCOM) component (e.g., global positioning system (GPS) transceiver), and/or a wireless modem, all of which are collectively represented at 44 in FIG. 1. Short-range communication (SRC) capabilities may be provided via a close-range communication device 46 (e.g., a BLUETOOTH® unit or near field communications (NFC) transceiver), UWB or LPWAN comm device, a dedicated short-range communications (DSRC) component 48, and/or a dual antenna 50. The communications devices described above may provision data exchanges as part of a periodic broadcast in a vehicle-to-vehicle (V2V) communications network or a vehicle-to-everything (V2X) communications network, e.g., Vehicle-to-Infrastructure (V2I), Vehicle-to-Pedestrian (V2P), Vehicle-to-Device (V2D), etc. It is envisioned that the vehicle 10 may be implemented without one or more of the above listed components or, optionally, may include additional components and functionality as desired for a particular end use.

CPU 36 receives sensor data from one or more sensing devices that use, for example, photo detection, radar, laser, ultrasonic, optical, infrared, or other suitable technology, including short-range communications technologies (e.g., DSRC, ad-hoc mesh LAN, BLUETOOTH® or BLE®) or Ultra-Wide Band (UWB) radio technologies, e.g., for executing an automated vehicle operation or a vehicle navigation service. In accord with the illustrated example, the automobile 10 may be equipped with one or more digital cameras 62, one or more range sensors 64, one or more vehicle speed sensors 66, one or more vehicle dynamics sensors 68, and any requisite filtering, classification, fusion, and analysis hardware and software for processing raw sensor data. The type, placement, number, and interoperability of the distributed array of in-vehicle sensors may be adapted, singly or collectively, to a given vehicle platform for achieving a desired level of automation and concomitant autonomous vehicle operation.

To propel the motor vehicle 10, an electrified powertrain is operable to generate and deliver tractive torque to one or more of the vehicle's drive wheels 26. The vehicle's electrified powertrain is generally represented in FIG. 1 by an electric traction motor 78 that is operatively connected to a rechargeable energy storage system (RESS), which may be in the nature of a chassis-mounted traction battery pack 70. The traction battery pack 70 may be generally composed of one or more battery modules 72 each containing a group of electrochemical battery cells 74, such as lithium ion, lithium polymer, or nickel metal hydride battery cells. Traction motor/generator (M) unit 78 draws electrical power from and, optionally, delivers electrical power to the battery pack 70. A power inverter module (PIM) 80 electrically connects the battery pack 70 to the motor/generator unit(s) 78 and modulates the transfer of electrical current therebetween. The battery pack 70 may be configured such that module management, cell sensing, and module-to-module or module-to-host communications functionality is integrated directly into each module 72 and performed wirelessly via a wireless-enabled cell monitoring unit (CMU) 76.

Also shown in FIG. 1 is a mobile vehicle communications (MVC) system 82 that enables wireless communications between remotely located computing nodes and one or more motor vehicles 10. MVC system 82 is represented herein by a constellation of GPS satellites 84, a wireless services satellite 86, an uplink transmitting station 88, a cellular (cell) transceiver tower 90, and a mobile switching center (MSC) 92. A host vehicle's GPS transceiver 44 may exchange radio signals with the GPS satellites 84 to derive real-time or near real-time geopositional and time data for the vehicle 10, which may be used to provide navigation and other related services to vehicle occupants. Wireless services satellite 86, through cooperative operation with the uplink transmitting station 88, provisions unidirectional and bidirectional communications with the vehicle 10, such as satellite radio and media services (e.g., music, news, videos, etc.) and satellite telephony services (e.g., to contact a remote vehicle command center). While shown with a single vehicle 10 communicating with multiple GPS satellites 84, a single wireless services satellite 86, a single uplink station 88, a single cell tower 90, and a single MSC 92, MVC system 82 may incorporate any number and combination of the foregoing elements as well as other available and hereafter developed communications hardware.

The MVC system 82 may operate within a cellular communications system 96, which is represented in FIG. 1 by one or more cell towers 90, one or more mobile switching centers 92, as well as any other networking components needed to link the cellular communications system 96 with assorted end nodes (e.g., BO host service 24). Each cell tower 90 may be equipped with a respective set of sending and receiving antennas for exchanging radio signals with vehicles 10. Base stations of the different cell towers may be connected to the MSC 92 either directly or via intermediary equipment, such as a base station controller (not shown). The cellular communications system 96 may implement any suitable communications technology, including earlier cellular protocols, such as cellular digital packet data (CDPD) 2G technologies, or contemporary cellular protocols, such as 4G-LTE of 5G-Advanced technologies. Vehicle telematics unit 14 may function as a cellular-enabled mobile component that is registered with a cellular carrier to transmit network data packets to and from the cellular communications system 96. It should be appreciated that the system 96 may take on innumerable tower/station/MSC arrangements, including co-location of a base station and a cell tower at the same site, remotely locating base stations and cell towers from one another, a single base station servicing a single cell tower, a single cell servicing multiple cell towers, and coupling multiple base stations to a single MSC, to name but a few possible arrangements.

Many modern-day automobiles come originally equipped with SRC-enabled remote control devices, typically in the nature of a key fob or similar form factor, for controlling various vehicle services, such as activating a vehicle alarm system, locking and unlocking vehicle doors, opening and closing vehicle doors, remotely starting the engine, turning on/off vehicle lights, etc. To enable long-range activation of these and other remote vehicle services, including remote ignition block, remote vehicle locator, etc., dedicated mobile applications (app) have been developed for smartphones and other wireless-enabled portable computing devices that allow the vehicle owner/user to control vehicle operation using cellular and satellite networks that eliminate spatial boundaries. However, LRC-based operation of RVS features is predominantly reliant upon publicly accessible communications networks that oftentimes do not provide reliable signal quality and signal strength. This may be particularly problematic in situations in which the inability to activate/deactivate an RVS renders the subject vehicle incapacitated or inoperable.

Discussed below are systems and methods for automating qualification checks for remote vehicle services based on real-time and predicted wireless signal states of a subject “host” vehicle. By way of non-limiting example, a backend BO vehicle service system estimates a probability of future successful remote service execution for a subject vehicle in an ignition-off state with RIB active based on cellular signal strength and/or quality available to that vehicle at the time of initial service initiation. By monitoring and retrieving cellular signal state data at the time of initial service initiation, along with historical and crowd-sourced signal information, the system can determine if a variance of cellular signal strength/quality over time about the retrieved value will be sufficiently strong in the future (e.g., X.XX hours, YY days, etc.) to ensure successful RVS execution such that the vehicle is not inadvertently locked in a RIB state. Application of this protocol may be of particular value in situations in which the remote vehicle service is a remote ignition block or similar feature that renders the vehicle incapacitated or inoperable.

Disclosed smart vehicle systems and control logic may predict an initial probability of successful RVS activation/deactivation at an initial point-in-time (e.g., when RIB is requested but before it is enabled) and a future probability at a near/mid-term future point-in-time (e.g., after RIB is enabled and when likely to request deactivation). After predicting a probability success, the RVS control algorithm may automate a remediating action based on that prediction (e.g., attempt to remotely disable RIB before cellular signal strength/quality is lost). The smart vehicle system may crowdsource signal state data from neighboring vehicles to create a cell signal heatmap in the area surrounding the host vehicle. The system may systematically monitor host and crowd-sourced vehicle signal data in order to continually update the signal state heatmap. A spatiotemporal forecasting (STF) model may be used to predict signal strength/quality of the subject vehicle and its surrounding area; the system may automate vehicle action and user notifications based on the STF model in order to provide closed-loop feedback to the user.

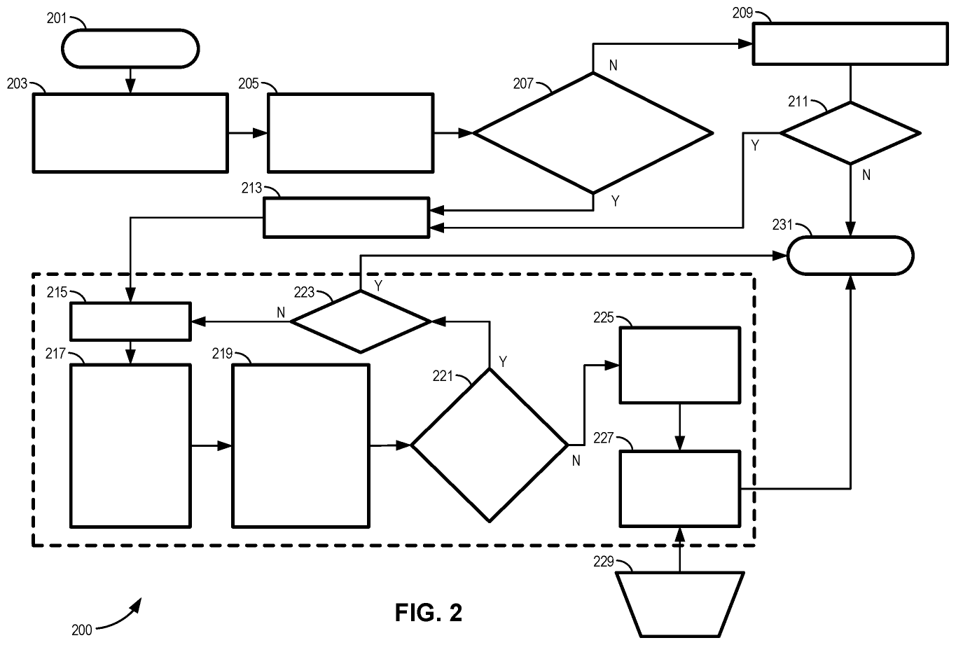

With reference next to the flow chart of FIG. 2, an improved method or control strategy for provisioning a remote vehicle service, such as RIB control via BO vehicle host service 24 of FIG. 1, for a host vehicle, such as automobile 10 of FIG. 1, is generally described at 200 in accordance with aspects of the present disclosure. Some or all of the operations illustrated in FIG. 2 and described in further detail below may be representative of an algorithm that corresponds to non-transitory, processor-executable instructions that are stored, for example, in main or auxiliary or remote memory (e.g., vehicle memory device 38 and/or host server database 98 of FIG. 1), and executed, for example, by an electronic controller, processing unit, dedicated control module, logic circuit, or other module or device or network of modules/devices (e.g., vehicle CPU 36 and/or BO host service 24 server of FIG. 1), to perform any or all of the above and below described functions associated with the disclosed concepts. It should be recognized that the order of execution of the illustrated operation blocks may be changed, additional operation blocks may be added, and some of the herein described operations may be modified, combined, or eliminated.

Method 200 begins at START terminal block 201 of FIG. 2 with memory-stored, processor-executable instructions for a programmable controller or control module or similarly suitable processor to call up an automated qualification check procedure for a requested RVS operation. This routine may be executed in real-time, near real-time, continuously, systematically, sporadically, and/or at regular intervals, for example, each 10 or 100 milliseconds during regular and routine operation of the motor vehicle 10. As yet another option, terminal block 201 may initialize responsive to a user command prompt (e.g., via telematics input controls 32), a resident vehicle controller prompt (e.g., from CPU 36), or a broadcast prompt signal received from a centralized backend vehicle services system (e.g., from BO host service 24). By way of non-limiting example, the method 200 may automatically initialize in response to an owner or operator of the motor vehicle 10 of FIG. 1 accessing a dedicated mobile application on their smartphone and selecting an option to active RIB. Terminal block 201 may also be triggered upon receipt of an RVS activation request from other authorized entities (e.g., first responder or BO call-center representative) to activate other RVS operations (e.g., RES, RKE, AVL, etc.). Moreover, these requests may be received via a vehicle controller either directly from the requesting party or indirectly via the BO vehicle service or other middleware node. Upon completion of some or all of the control operations presented in FIG. 2, the method 200 may advance to END terminal block 231 and temporarily terminate or, optionally, may loop back to terminal block 201 and run in a continuous loop.

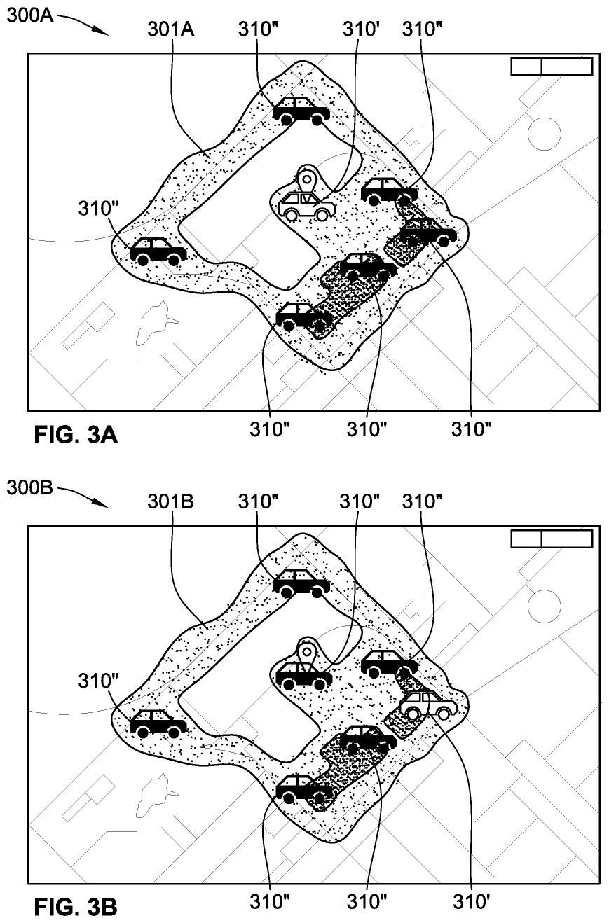

Advancing from terminal block 201 to SIGNAL STATE data input block 203, method 200 executes memory-stored instructions to collect signal state data indicative of a real-time or near real-time signal state proximal to the host vehicle. In accord with the illustrated example, the smart vehicle system may actively measure the cellular signals of a host vehicle (e.g., host vehicle 310′ of FIGS. 3A and 3B) and a select set of participating “crowd-sourced” vehicles (e.g., crowd-sourced vehicle 310″ of FIGS. 3A and 3B) within an X-mile radius of the host vehicle. Upon receipt of an RVS activation request, for example, the vehicle CPU 36 and/or BO host service 24 server may responsively communicate with each vehicle to retrieve wireless signal data indicative of a wireless signal state (e.g., signal quality (decibels (dB)) and/or signal strength (decibel milliwatts (dBm)) of the host vehicle and each crowd-sourced vehicle within a predefined proximity to the host vehicle (e.g., one (1) km diameter). In telecommunications, signal strength typically refers to the transmitter power output as received by a reference antenna at a distance from the transmitting antenna. Cellular signal strength, which may be reported as Reference Signal Received Power (RSRP), is typically measured in decibel milliwatts and may range from approximately −30 dBm to −110 dBm. In general, a signal strength better than about −50 dBm (i.e., closer to zero) is considered a strong signal, a signal strength better than about −85 dBm is considered a usable signal, and a signal strength worse than about −100 dBm is considered a weak signal. To minimize memory storage space and processor load, data input block 203 may only collect RSRP cellular signal strength data.

In comparison to signal strength, signal quality may represent a level of interference that exists between a reference device and a signal-transmitting tower. Cellular signal quality, which may be expressed as Reference Signal Received Quality (RSRQ), is typically measured in decibels and generally ranges from about zero (0) dB (high quality) to about −20 dB (poor quality). In general, a signal quality greater than about −8 dB is considered a superior signal quality, a signal quality between about −9 dB and −12 dB is considered an acceptable signal quality, and a signal quality less than about −12 dB is considered an inferior signal quality. In at least some applications, each vehicle's telematics modem module monitors, updates, and stores cellular signal strength and quality; this data is transferred to the BO for aggregation, preprocessing, and analysis.

After collecting available wireless signal state information at data input block 203, method 200 executes SIGNAL STATE HEATMAP predefined process block 205 and creates a signal state heatmap for the host vehicle. By way of example, and not limitation, the vehicle CPU 36 and/or BO host service 24 server uses the wireless signal states of the host and crowd-sourced vehicles to dynamically generate a signal state heatmap with a spatial mapping of signal state magnitudes that is overlaid on a plan-view geographic map of the host vehicle's surrounding area. This signal state heatmap depicts a signal state magnitude in an immediate area surrounding the host vehicle. In general, a spatial heatmap may graphically visualize the magnitudes of a spatial phenomenon as different colors or as a two-dimensional (2D) dot-density plot cast over a “birds-eye-view” map. To generate a signal state heatmap, each vehicle's respective cellular signal state may be associated with a real-time geoposition data set; the signal state value may be converted to a positive-integer signal state magnitude in accordance with a predetermined scale (e.g., 0 to −30 dBm=10; −31 to −40 dBm=9; −41 to −50 dBm=8, . . . 111 to −120 dBm=1; ≤−121=0). Host and crowd-sourced signal state magnitude values may then be plotted in accordance with their respective geopositional data; the magnitude values are then transformed according to an associated dot-density map or colormap (e.g., largest values red, large values reddish-orange, medium values orange, medium-low values yellowish-orange, low values yellow, lowest or near-zero values green).

FIGS. 3A and 3B present screenshots 300A and 300B, respectively, of an in-vehicle telematics unit display with two examples of dynamically generated signal state heatmaps 301A and 301B that spatially map wireless signal strength and/or quality magnitudes of a host vehicle 310′ and neighboring crowd-sourced vehicles 310″. FIG. 3A, for example, shows a signal state heatmap 301A that is overlaid onto a geographic information system (GIS) based map with the host vehicle 310′ located in a poor signal state area—designated with a greenish hue or sparsely populated dots—with a low signal state magnitude (e.g., signal strength of about −105 to −110 dBm). By contrast, FIG. 3B shows another representative signal state heatmap 301B with the host vehicle 310′ located in a robust signal state area—designated with a reddish hue or densely populated dots—with a high signal state magnitude (e.g., signal strength of about −45 to −55 dBm). Creating, updating, and forecasting signal state heatmaps, as described herein, provides the smart vehicle system with a more accurate and complete picture of host signal state in the area surrounding the host vehicle as compared to qualification-check methodologies that are limited to analyzing a single, localized point of reference.

After generating a signal state heatmap for the subject vehicle at predefined process block 205, method 200 of FIG. 2 proceeds to SIGNAL STATE THRESHOLD decision block 207 to assess whether or not a signal state magnitude of the host vehicle is above a corresponding minimum allowable value. For instance, vehicle CPU 36 and/or BO host service 24 server may determine if the signal state magnitude in the surrounding area of the host vehicle exceeds a preset minimum signal state threshold (e.g., greater than about −60 dBm/−10 dB). If not (Block 207=NO), method 200 responsively executes REQUEST DENIED signal output block 209 and transmits an electronic notification (e.g., via SMS/MMS text, push, email, automated call, etc.) to a user of the host vehicle with a warning that their request to start the RVS operation has been denied (“QUALIFICATION CHECK FAILED—RIB ACTIVATION DENIED”). At this juncture, method 200 may proceed directly to terminal block 231, i.e., omitting or skipping block 211, and temporarily terminate without activating the selected remote service.

As an alternative option, the host vehicle 10 or BO 24 may receive an electronic override request indicating that the vehicle user or other authorized party, after receiving the electronic notification output at block 209, has chosen to override the denial of the RVS operation. To this end, if the method 200 determines at OVERRIDE REQUEST decision block 211 that an electronic override request has not been received (Block 211=NO), method 200 may proceed to terminal block 231 and temporarily terminate without activating the selected remote vehicle service. Upon determining that an override request has been received (Block 211=YES), method 200 may responsively activate the requested remote vehicle service at process block 213.

After confirming that the cellular signal of the host vehicle and immediate neighboring vehicles is above the minimum allowable signal threshold (Block 207=YES), method 200 of FIG. 2 may responsively execute RVS ACTIVATION predefined process block 213 and activate the requested vehicle service. By way of example, BO host service 24 may transmit an electronic approval alert to the host vehicle 10 with an indicator that the qualification check was successful and the request to start the RVS operation has been approved. At the same time, the vehicle telematics unit 14 or other suitable in-vehicle device may output a corresponding warning to the occupant(s), if any, within the passenger compartment of the vehicle 10 (“QUALIFICATION CHECK PASSED—RIB ACTIVATION APPROVED”). At this juncture, one or more resident vehicle controllers (e.g., CPU 36 of FIG. 1) may respond to receipt of the RVS approval notification by commanding one or more resident vehicle subsystems to singly or cooperatively execute the requested RVS operation. As noted above, the automobile 10 is propelled by an electrified powertrain with a traction motor 78 that is controlled, at least in part, by a Powertrain Control Module 52; at process block 213, the telematics CPU 36 may transmit one or more command signals to the PCM 52 to activate remote ignition block and, thus, prevent activation/operation of the traction motor 78. It may be desirable, for at least some implementations, that the method 200 conduct additional vehicle system checks before activating the requested RVS. For a RIB operation, the telematics unit 14 may first confirm that the subject vehicle 10 is stopped (or idling), is located in a secure area (e.g., not obstructing a roadway or intersection), and/or the prime mover is keyed-off.

With continuing reference to FIG. 2, the method 200 may enter a process time delay operation that lasts a predefined wait time (e.g., one (1) minute refresh rate) at SIGNAL STATE REFRESH process block 215. Upon completion of this process time delay, method 200 executes NEW SIGNAL STATE data input block 217 to measure and store new wireless signal data that is indicative of a new signal state proximal to the host vehicle. After activating a requested RIB (Block 213) and waiting at least T-minutes (Block 215), for example, the vehicle CPU 36 and/or BO host service 24 server communicates with the host vehicle 310′ and participating crowd-sourced vehicles 310″ within X-distance of the host 310′ to retrieve new cellular signal data that is indicative of new wireless signal states for the host vehicle and crowd-sourced vehicles. At the same time, the CPU 36 and/or BO 24 server may access a resident or remote memory device, such as memory device 38 and/or host server database 98, to retrieve historical signal state data of the host vehicle and crowd-sourced vehicles for the vehicle's current location.

Advancing from data input block 217 to PREDICTED SIGNAL STATE HEATMAP predefined process block 219, method 200 employs a spatiotemporal forecasting (STF) model to derive an updated (“predicted”) signal state heatmap with a spatial mapping of predicted signal state magnitudes. Similar to generating and visualizing the signal state magnitudes for process block 205, these predicted signal state magnitudes may be graphically visualized as a new map overlay that is cast onto the plan-view geographic map of the host vehicle's current location and include a predicted host signal state magnitude in the surrounding area of the host vehicle. For example, BO host service 24 server may implement a deep-learning STF framework or a machine-learning statistical STF technique that uses as inputs the newly acquired and memory-stored historical wireless signal states for the host vehicle and crowd-sourced vehicles to predict what the host vehicle's cellular signal state will be at a future time (e.g., at 5 mins, 10 mins, 15 mins, 30 mins, 60 mins, 120 mins, and so on). Deriving a predicted signal state heatmap may also necessitate identifying one or more transient regions in the signal state heatmap, each of which is located between an adjacent pair of available signal state magnitudes yet lacks its own signal state magnitude. Once identified, the BO server then estimates a transient signal state magnitude for each transient region by interpolating the adjacent signal state magnitudes for that region.

After deriving a predicted signal state heatmap for the subject vehicle at predefined process block 219, method 200 of FIG. 2 proceeds to PREDICTED SIGNAL STATE THRESHOLD decision block 221 to assess whether or not a predicted signal state magnitude of the host vehicle exceeds the above-noted minimum allowable value. In a non-limiting example, vehicle CPU 36 and/or BO host service 24 server may determine if the predicted signal state magnitude in the surrounding area of the host vehicle exceeds the preset minimum signal state threshold (e.g., greater than about −60 dBm/−10 dB). If so (Block 221=YES), method 200 responsively executes RVS DEACTIVATION REQUEST decision block 223 to determine if the system has received a valid request from the vehicle user or other authorized user to deactivate the now-active vehicle service. If a valid deactivation request was received (Block 223=YES), method 200 may loop forward to END terminal block 231 and stop. Conversely, if a valid deactivation request was not received (Block 223=NO), method 200 may loop back to process block 215 and complete the signal refresh rate delay before looping back through blocks 217, 219 and 221.

Responsive to a determination that the predicted signal state magnitude in the surrounding area of the host vehicle does not exceed the preset minimum signal state threshold (Block 221=NO), method 200 executes RVS EXIT signal output block 225 and transmits an electronic notification (e.g., via SMS/MMS text, push, email, automated call, etc.) to a user of the host vehicle with a warning that the presently active RVS operation will be deactivated (“CELLULAR SIGNAL INSUFFICIENT—RIB DEACTIVATING”). At this juncture, the vehicle CPU 36 responsively commands the appropriate resident vehicle subsystem(s) to deactivate the RVS operation, as indicated at RVS DEACTIVATION predefined process block 227. At any time after activating the requested vehicle service (Block 213), the host vehicle 10 or BO host service 24 may receive an RVS deactivation signal indicative of a user or authorized party request to deactivate the RVS operation, as indicated at USER DEACTIVATION manual input process block 229. If a user-generated deactivation request is received, method 200 may responsively execute process block 227 and deactivate the RVS operation.

Aspects of this disclosure may be implemented, in some embodiments, through a computer-executable program of instructions, such as program modules, generally referred to as software applications or application programs executed by any of a controller or the controller variations described herein. Software may include, in non-limiting examples, routines, programs, objects, components, and data structures that perform particular tasks or implement particular data types. The software may form an interface to allow a computer to react according to a source of input. The software may also cooperate with other code segments to initiate a variety of tasks in response to data received in conjunction with the source of the received data. The software may be stored on any of a variety of memory media, such as CD-ROM, magnetic disk, and semiconductor memory (e.g., various types of RAM or ROM).

Moreover, aspects of the present disclosure may be practiced with a variety of computer-system and computer-network configurations, including multiprocessor systems, microprocessor-based or programmable-consumer electronics, minicomputers, mainframe computers, and the like. In addition, aspects of the present disclosure may be practiced in distributed-computing environments where tasks are performed by resident and remote-processing devices that are linked through a communications network. In a distributed-computing environment, program modules may be located in both local and remote computer-storage media including memory storage devices. Aspects of the present disclosure may therefore be implemented in connection with various hardware, software, or a combination thereof, in a computer system or other processing system.

Any of the methods described herein may include machine readable instructions for execution by: (a) a processor, (b) a controller, and/or (c) any other suitable processing device. Any algorithm, software, control logic, protocol, or method disclosed herein may be embodied as software stored on a tangible medium such as, for example, a flash memory, a solid-state drive (SSD) memory, a hard-disk drive (HDD) memory, a CD-ROM, a digital versatile disk (DVD), or other memory devices. The entire algorithm, control logic, protocol, or method, and/or parts thereof, may alternatively be executed by a device other than a controller and/or embodied in firmware or dedicated hardware in an available manner (e.g., implemented by an application specific integrated circuit (ASIC), a programmable logic device (PLD), a field programmable logic device (FPLD), discrete logic, etc.). Further, although specific algorithms may be described with reference to flowcharts and/or workflow diagrams depicted herein, many other methods for implementing the example machine-readable instructions may alternatively be used.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

What is claimed:

1. A method of controlling a remote vehicle service (RVS) operation of a host vehicle having a vehicle controller, a wireless communications device, and a resident vehicle subsystem operable to perform the RVS operation, the method comprising:
receiving, via the vehicle controller over the wireless communications device, an RVS activation signal indicative of a request to activate the RVS operation;
retrieving, responsive to receipt of the RVS activation signal, wireless signal data indicative of a host wireless signal state of the host vehicle and crowd wireless signal states of multiple crowd-sourced vehicles within a predefined proximity to the host vehicle;
generating, using the host wireless signal state and the crowd wireless signal states, a signal state heatmap with a spatial mapping of signal state magnitudes overlaid on a map and including a host signal state magnitude in a surrounding area of the host vehicle;
determining if the host signal state magnitude exceeds a preset minimum signal state threshold; and
transmitting, via the vehicle controller responsive to the host signal state magnitude exceeding the preset minimum signal state threshold, a command signal to the resident vehicle subsystem to activate the RVS operation.

2. The method of claim 1, further comprising:
retrieving, after transmitting the command signal to activate the RVS operation, new wireless signal data indicative of multiple new host wireless signal states of the host vehicle and multiple new crowd wireless signal states of each of the crowd-sourced vehicles; and
generating, using a spatiotemporal forecasting (STF) model with the new host wireless signal states and the new crowd wireless signal states as inputs to the STF model, a predicted signal state heatmap with a spatial mapping of predicted signal state magnitudes as a new map overlay and including a predicted host signal state magnitude in the surrounding area of the host vehicle.

3. The method of claim 2, further comprising:
determining if the predicted host signal state magnitude exceeds the preset minimum signal state threshold; and
transmitting, via the vehicle controller responsive to the predicted host signal state magnitude not exceeding the preset minimum signal state threshold, a deactivation command signal to the resident vehicle subsystem to deactivate the RVS operation.

4. The method of claim 3, wherein generating the predicted signal state heatmap further includes:
retrieving, from a memory device, historical host wireless signal states of the host vehicle and historical crowd wireless signal states of each of the crowd-sourced vehicles; and
using the historical host wireless signal states and the historical crowd wireless signal states as inputs to the STF model to generate the predicted signal state heatmap.

5. The method of claim 3, further comprising transmitting, responsive to the predicted host signal state magnitude not exceeding the preset minimum signal state threshold, an electronic notification to a user of the host vehicle warning that the RVS operation is being deactivated.

6. The method of claim 3, further comprising:
completing, responsive to the predicted host signal state magnitude exceeding the preset minimum signal state threshold, a time delay operation lasting a predefined wait time;
retrieving, after completing the time delay operation, more new wireless signal data indicative of more new host wireless signal states of the host vehicle and more new crowd wireless signal states of each of the crowd-sourced vehicles; and
generating, using the more new host wireless signal states and the more new crowd wireless signal states as inputs to the STF model, a new predicted signal state heatmap with a spatial mapping of new predicted signal state magnitudes as another new map overlay and including a new predicted host signal state magnitude in the surrounding area of the host vehicle.

7. The method of claim 1, further comprising:
receiving, via the vehicle controller over the wireless communications device, an RVS deactivation signal indicative of a request to deactivate the RVS operation; and
transmitting, via the vehicle controller responsive to receipt of the RVS deactivation signal, a deactivation command signal to the resident vehicle subsystem to deactivate the RVS operation.

8. The method of claim 1, wherein generating the signal state heatmap further includes:
identifying a transient region in the signal state heatmap located between an adjacent pair of the signal state magnitudes and lacking a signal state magnitude; and
estimating a transient signal state magnitude for the transient region by interpolating the adjacent pair of the signal state magnitudes.

9. The method of claim 1, further comprising transmitting, responsive to the host signal state magnitude not exceeding the preset minimum signal state threshold, an electronic notification to a user of the host vehicle warning that activation of the RVS operation is denied.

10. The method of claim 9, further comprising:
receiving, after transmitting the electronic notification to the user of the host vehicle, an electronic override signal indicative of a user-selection from the user to override the denial of the RVS operation; and
transmitting, via the vehicle controller responsive to receipt of the electronic override signal, the command signal to the resident vehicle subsystem to activate the RVS operation.

11. The method of claim 1, wherein receiving the RVS activation signal includes a user of the host vehicle entering the request to activate the RVS operation via a wireless-enabled personal computing device, and the personal computing device transmitting the RVS activation signal over a cellular network either directly to the vehicle controller or indirectly to the vehicle controller via a back-office vehicle services system.

12. The method of claim 1, wherein the resident vehicle subsystem includes a vehicle powertrain with a prime mover and a powertrain control module (PCM), the RVS operation includes a remote ignition block (RIB) operation, and the command signal causes the PCM to prevent activation of the prime mover.

13. The method of claim 1, wherein the host wireless signal state and the crowd wireless signal states each includes a corresponding signal strength value and/or a corresponding signal quality value.

14. Non-transitory, computer-readable media storing instructions executable by a host vehicle with a vehicle controller and/or a vehicle services system with a system controller, the host vehicle including a wireless communications device and a resident vehicle subsystem operable to perform a remote vehicle service (RVS) operation, the instructions, when executed, causing the vehicle controller and/or the system controller to perform operations comprising:
receiving, via the vehicle controller over the wireless communications device, an RVS activation signal indicative of a request to activate the RVS operation;
retrieving, via the system controller responsive to receipt of the RVS activation signal, wireless signal data indicative of a host wireless signal state of the host vehicle and crowd wireless signal states of multiple crowd-sourced vehicles within a predefined proximity to the host vehicle;
generating, via the system controller using the host wireless signal state and the crowd wireless signal states, a signal state heatmap with a spatial mapping of signal state magnitudes overlaid on a map and including a host signal state magnitude in a surrounding area of the host vehicle;
determining, via the system controller, if the host signal state magnitude exceeds a preset minimum signal state threshold; and
transmitting, via the vehicle controller responsive to the host signal state magnitude exceeding the preset minimum signal state threshold, a command signal to the resident vehicle subsystem to activate the RVS operation.

15. A smart vehicle network, comprising:
a host vehicle including a vehicle controller, a wireless communications device, and a resident vehicle subsystem operable to perform a remote vehicle service (RVS) operation, the vehicle controller being programmed to:
receive, over the wireless communications device, an RVS activation signal indicative of a request to activate the RVS operation; and
transmit, responsive to receiving an RVS approval notification, a command signal to the resident vehicle subsystem to activate the RVS operation; and
a back-office vehicle services system with a system controller operable to wirelessly communicate with host vehicle, the system controller being programmed to:
retrieve, responsive to receipt of the RVS activation signal, wireless signal data indicative of a host wireless signal state of the host vehicle and crowd wireless signal states of multiple crowd-sourced vehicles within a predefined proximity to the host vehicle;
generate, using the host wireless signal state and the crowd wireless signal states, a signal state heatmap with a spatial mapping of signal state magnitudes as an overlay on a map and including a host signal state magnitude in a surrounding area of the host vehicle;
determine if the host signal state magnitude exceeds a preset minimum signal state threshold; and
transmit, responsive to the host signal state magnitude exceeding the preset minimum signal state threshold, the RVS approval notification to the host vehicle.

16. The smart vehicle network of claim 15, wherein the system controller is further programmed to:
retrieve, after activation of the RVS operation, new wireless signal data indicative of multiple new host wireless signal states of the host vehicle and multiple new crowd wireless signal states of each of the crowd-sourced vehicles; and
generate, using a spatiotemporal forecasting (STF) model with the new host wireless signal states and the new crowd wireless signal states as inputs to the STF model, a predicted signal state heatmap with a spatial mapping of predicted signal state magnitudes as a new map overlay and including a predicted host signal state magnitude in the surrounding area of the host vehicle.

17. The smart vehicle network of claim 16, wherein the system controller is further programmed to:
determine if the predicted host signal state magnitude exceeds the preset minimum signal state threshold; and
transmit, to the vehicle controller responsive to the predicted host signal state magnitude not exceeding the preset minimum signal state threshold, a deactivation command signal to deactivate the RVS operation.

18. The smart vehicle network of claim 17, wherein generating the predicted signal state heatmap further includes:
retrieving, from a memory device, historical host wireless signal states of the host vehicle and historical crowd wireless signal states of each of the crowd-sourced vehicles; and
using the historical host wireless signal states and the historical crowd wireless signal states as inputs to the STF model to generate the predicted signal state heatmap.

19. The smart vehicle network of claim 17, wherein the system controller is further programmed to transmit, responsive to the predicted host signal state magnitude not exceeding the preset minimum signal state threshold, an electronic notification to a user of the host vehicle warning that the RVS operation is being deactivated.

20. The smart vehicle network of claim 15, wherein the resident vehicle subsystem includes a vehicle powertrain with a prime mover and a powertrain control module (PCM), the RVS operation includes a remote ignition block (RIB) operation, and the command signal causes the PCM to prevent activation of the prime mover.
